(19) United States
(12) Patent Application Publication
(10) Pub. No.: US 2003/0145037 A1
(43) Pub. Date: Jul. 31, 2003

(54) Network management system using sms

(76) Inventor: Marcus Von Garssen, Dusseldorf (DE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/204,244

(22) PCT Filed: Feb. 15, 2001
(86) PCT No.: PCT/FI01/00145

(30) Foreign Application Priority Data
Feb. 16, 2000 (FI) 20000342

(51) Int. Cl. G06F 15/16

(52) U.S. Cl. 709/201

(57) ABSTRACT

The idea of the invention is to use known short message services for the needs of network management. Management tasks can be carried out wirelessly through a mobile system. Commands and monitoring are carried out in a mobile station (15), and communication goes through a mobile system to a network element (11) with a mobile transceiver (22). The network management system has been adapted to operate in a wireless environment. This provides opportunities for speedy installation and operation, and for management of a network element from any location with a mobile system, as well as, a simple means for arranging back-up route for network management.

### FIELD OF THE INVENTION

The invention relates generally to the management of a data/telecommunications network, and especially to systems intended for carrying out management tasks. The network management system manages the whole network, and controls and monitors individual network elements.

### BACKGROUND OF THE INVENTION

A data/telecommunications network needs a management system to run it. Tasks of the management system are: to detect, isolate and correct faults, to configure network elements, to control the billing aspect of a telecommunications network, to gather various statistics about data such as bit error rates, alarms and traffic load, and to control the security of the network. The network management can be centralized, whereby a great deal of management tasks are carried out in one location, or it can be decentralized, whereby management tasks are distributed to several locations in the network. The difference between the centralized and the decentralized system is not always so clear, because in many cases it is reasonable to take care of certain matters locally. In other words, management tasks can be prioritized for being carried out at different levels of the network hierarchy.

In many cases, present systems are centralized systems running at many different levels. FIG. 1 illustrates an example of a typical management system. Network elements NE (11) are connected to the management system through standardized interfaces Q3—directly to a management centre OSF (Operations System Function) (13) or through DCN (Data Communications Network) (12), which is the part of the network for handling management traffic. The management system can be used through the workstations WS (14), which are connected to the management system via standardized F-interfaces. A workstation can be directly connected to a network element, when it is connected via a Q3-interface. A Telecommunication Management Network TMN is composed of an OSF, a DCN, interfaces between different parts of the network, and of course, management software and hardware in each network element. A TMN can be connected to another TMN through a standardized X-interface.

Also known is the use of Internet or Intranet for management tasks. In that case, there is an ordinary www-browser in a workstation, with which it is possible to make a connection to a network element using the IP-address of the network element. Normally there is also a www-server in a network (located, for example, in the OSF) which handles connections between network elements and workstations. The www-server can also have management software for network elements. Such management software can perform a portion of the management tasks of a network element through HTTP connections.

There are drawbacks in known network management systems depending on a dedicated fixed DCN. In many present systems the planning, installation and operation of a DCN is a very complex, error-prone and expensive process, because of a multitude of different management interfaces and dedicated data links and network elements that often have to be installed specifically for the DCN. E.g. the design of backup routes for different faults and interruptions caused by faults require considerable work. Also in many present systems the DCN is installed at the same time as the network for user traffic. So it cannot be used during this phase. The goal of this invention is to reduce these drawbacks.

### SUMMARY OF THE INVENTION

The objective of the invention is achieved in ways described in the independent claims. The idea of the invention is to use known short message services for the needs of network management. Management tasks can be carried out wirelessly through a mobile system. Commands and monitoring are carried out in a mobile station, and communication goes through a mobile system to a network element with a mobile transceiver. The network management system has been adapted to operate in a wireless environment. This provides opportunities for speedy installation and operation, and for management of a network element from any location with a mobile system, as well as, a simple means for arranging back-up route for network management.

### BRIEF DESCRIPTION OF THE DRAWINGS

In the following the invention is described in more detail by means of the attached figures, of which

FIG. 1 illustrates an example of a known network management system,

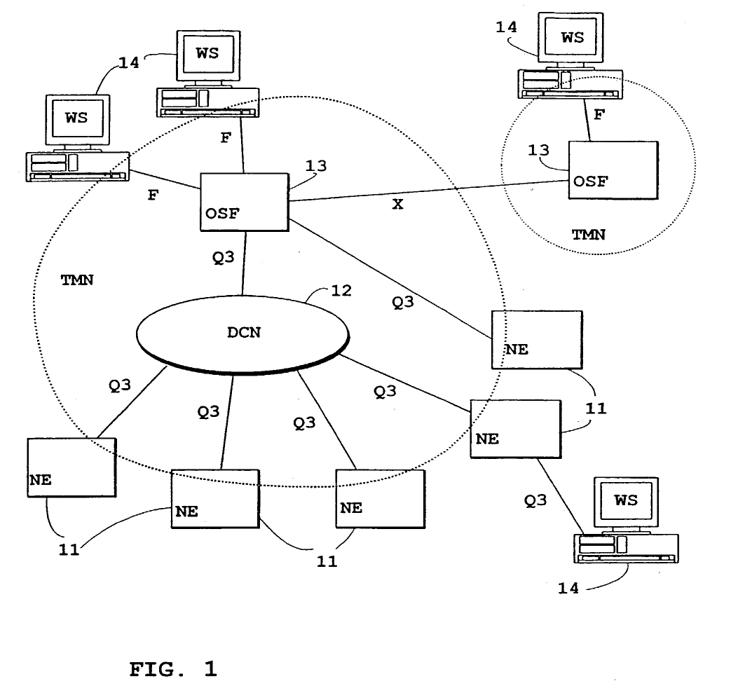

FIG. 2 illustrates an example of a network management system according to the invention.

### DETAILED DESCRIPTION OF THE INVENTION

The network management system according to the invention takes advantage of short message services SMS of a GSM environment. The SMSO also offers a working environment for a network management system if the special features of the SMS are provided for, while the network for user traffic is being created.

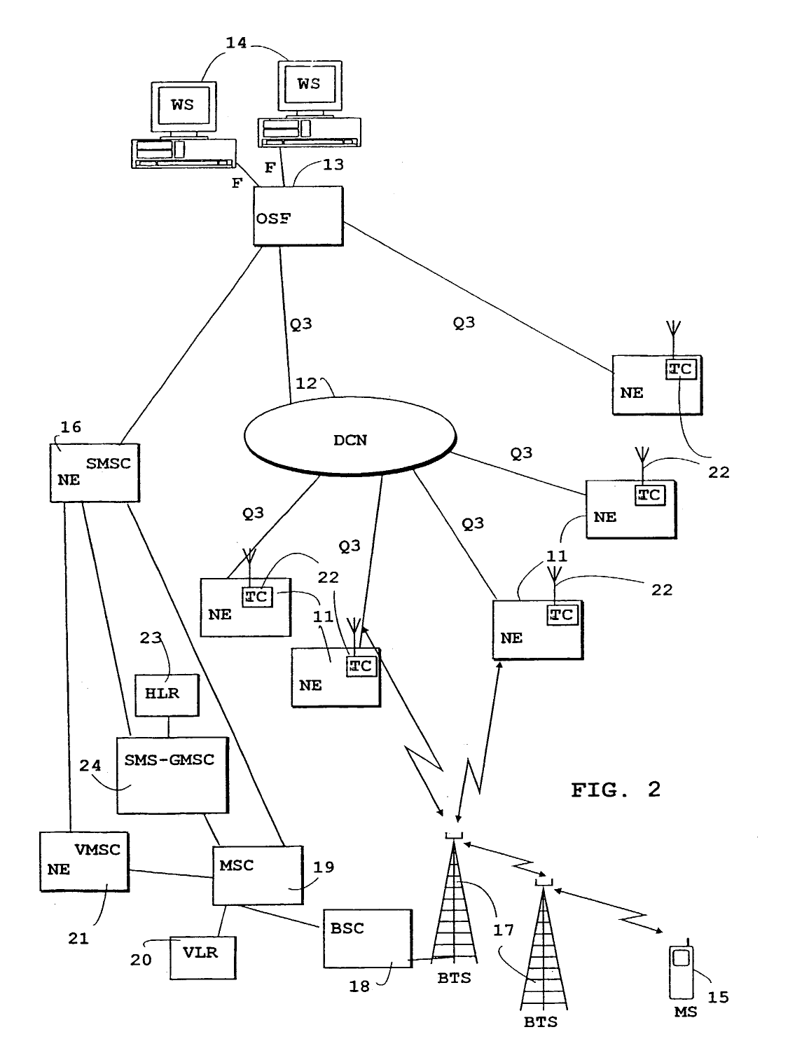

In FIG. 2 there is an example of a management system according to the invention. When a user wants to perform a management operation on a network element, the user sends a short message, called a mobile originated message MO from a mobile station MS (15) to a Short Message Service Center SMSC (16), which stores and passes on messages. The address of the network element is the phone number to which the user sends the short message. The connection to the SMSC is made as normally way through the GSM network. The message travels through base stations BTS (17), and a base station controller BSC (18) to a mobile switching center MSC (19), which checks the subscriber's data, such as International Mobile Subscriber Identity (IMSI), from the visitor location register VLR (20) MSC, and routes the MO message directly to a SMSC or alternatively to another mobile switching center VMSC (visitor mobile switching center) (21), depending on the topology of the GSM network and on the location of the network element. The SMSC sends an acknowledgment to the subscriber.

After that the SMSC sends the short message, now called a mobile terminated message MT, through a GSM network as normally to the destination network element (11), which includes a GSM transceiver (22). The SMSC asks for the element's routing information from a home location register HLR (23) via a mobile switching center SMS-GSMSC (24), which has connections to the HLR. Next the SMSC routes the MT via a VMSC or directly to the MSC which requests the network element's location information from the VLR and then routes the MT to the network element. The network element sends back an acknowledgment. Short messages may include management commands from a workstation (mobile phone, desktop computer etc.) to a network element, as well as network element configuration data, monitoring information, and fault messages from a network element to a workstation etc.

SMSC also includes interfaces to other environments, so that it is possible to send short messages from fixed workstations, such as desktop computers. The SMSC is preferably connected to the network management centre in order to carry out the management tasks for the whole network. For example, a user generates a higher level operation short message on a workstation connected to the OSF, which in turn executes several lower level management operations based on the mentioned higher level operation short message. Another example is that the OSF sends short message management commands to another OSF (another OSF is like any network element), which executes commands. In this way, it is possible, for example, to set up end-to-end connection across multiple networks. OSF itself can also create certain short messages in cases, such as fault situations. However, it is preferable in all situations to send a notification short-message to a user terminal, summarizing the result of a management request. It is also possible to use both DCN channels and GSM short messages, so that GSM short messages can be a back-up route for a DCN route and vice versa.

So, the management staff can choose GSM or DCN network for management connections. In the case of GSM short messages the network operation staff initiates a management operation from its fixed workstation (14) connected to an OSF (13). The OSF (13) converts the request into an SMS message and addresses it to the concerned network element by specifying its GSM mobile subscriber number. This message is sent to the SMSC (16) through a fixed line connection. From there the SMS message is routed through the GSM network to a BTS (17) and over the air interface to the GSM transceiver module (22) of the network element (11). So it is possible that the managed network elements are addressed and identified by their International Mobile Subscriber Identity (IMSI).

The network element can spontaneously send a short message to the management staff without a separate request in matters such as fault situations. Thus through a wireless network, management staff can be reached more quickly and flexibly around the clock, also during the night and weekends and when they are not at an OSF site, so that the idle time of the network element decreases in fault situations because of faster repairs reconfiguration. For example, a network element (11) detects one or multiple fault conditions. It performs some filtering in order to determine the root causes of the faults. For each root cause an SMS message is generated, containing a fault identifier and fault parameters. For each root cause the network element has a configurable list of fault notification receivers. The SMS message is addressed to the complete list of receivers. Then the network element's GSM transceiver (22) transmits the message over the air interface to a BTS (17) From there it is routed through the GSM network to the receiving work stations.

SMS is a safe way to manage network elements because GSM encryption prevents unauthorized surveillance of the management traffic There is also authenticity verification by checking the sender subscriber number (or IMSI) before processing a message. The destination network element verifies that the message originated from an authorized source by comparing the sender's GSM mobile subscriber number with an internal access control list. If this is the case the requested operation is performed and an SMS message is returned to the sender indicating the success of the operation, and possibly including data requested from the network element.

Although the invention has been described in the light of the example, it is evident that the invention is not restricted to this solution. For example, it is possible to manage several network elements that are linked via fixed-line connections via a single common mobile network access (a transceiver (22)). So the invention can be modified for other solutions within the scope of the inventive idea.

1. An arrangement for managing network elements (11) in a telecommunication network in which a short message switching service is available for sending short messages, the arrangement comprising at least one workstation for managing the network elements and an network element including a transceiver (22), characterized in that the at least one workstation constitutes of a mobile user terminal (15) connected wirelessly to the telecommunication network and the network elements (11) are managed by sending management information between the mobile user terminal (15) and the network elements (11) in said short messages.

2. An arrangement according to claim 1, characterized in that network elements (11) are managed alternatively through a fixed network.

3. An arrangement according to claim 1, characterized in that network elements (11) are arranged to generate and send a short message automatically in response to a predetermined event, without a request from the mobile user terminal (15).

4. An arrangement according to any of claims 1 to 3, characterized in that a short message service center (16) providing said short message switching service is connected to the network management center (13) in order to carry out management of the whole network, the arrangement being organized hierarchically, such that at least one management center (13) acts like a managed network element (11) towards a higher layer management center (13).

5. An arrangement according to claim 3, characterized in that the response includes configuration data, monitoring information, fault information or any combination thereof.

6. An arrangement according to claim 3 characterized in that the response is addressed to predetermined network elements (11), configurable for each event type.

7. An arrangement according to claim 3, characterized in that the response is addressed to different configured network elements (11), depending on the set of parameter information content.

8. An arrangement according to claim 1, characterized in that the arrangement automatically sends the short-messages over an alternative mobile network if the default network fails to work properly.

9. An arrangement according to claim 1, characterized in that the managed network elements are addressed and identified by their International Mobile Subscriber Identity (IMSI).

10. An arrangement according to claim 9, characterized in that sender authenticity verification is performed by checking the International Mobile Subscriber Identity (IMSI) of a sending network element against an access control list on the part of the receiving network element.

11. An arrangement according to claim 1, characterized in that a management center (13) generates management short-messages automatically for requesting management operation.

12. An arrangement according to claim 11, characterized in that the management center (13) sends a notification short-message to the mobile user terminal (15), summarizing the result of the request.

13. An arrangement according to claim 1, characterized in that the managed network element (11) contains information filtering means and only sends information about the root cause of an event.

14. An arrangement according to claim 1, characterized in that several network elements (11) are linked via a fixed-line connections to be managed via a single common mobile network access (22).

15. A method of managing network elements (11) in a telecommunication network in which a short message switching service is available for sending short messages, the method comprising:
sending management information in a short message from a workstation provided by a mobile user terminal (15) via a wireless connection to the telecommunication network; and
managing an network element (11) including a transceiver (22) based on said management information included in said short message.
